(19) United States
(12) Patent Application Publication
(10) Pub. No.: US 2011/0206101 A1
(43) Pub. Date: Aug. 25, 2011

(54) TECHNIQUE FOR NOISE MITIGATION IN XDSL LINES

(76) Inventors: Avi Matza, Nes Ziona (IL); Ilan Sharfer, Rehovot (IL); Assaf Zeira, Moshav Bnei Atarot (IL)

(21) Appl. No.: 13/059,053

(22) PCT Filed: Jul. 27, 2009
(86) PCT No.: PCT/IL09/00727

§ 371 Date: May 2, 2011

(51) Int. Cl. H04L 5/16

(52) U.S. Cl. 375/222

(57) ABSTRACT

A practical technique for noise mitigation, based on the conventional DPBO, UPBO and VN technologies and enabling dynamic, more accurate determination of parameters required for management of transmission in xDSL channels. The technique combines the conventional noise mitigation techniques with systematic determining of crosstalk readings at each and every line of the xDSL binder, in particular with the DSM (Dynamic Spectrum Management) mechanism.

### FIELD OF THE INVENTION

The present invention generally relates to broadband communications. More particularly, it relates to digital subscriber line noise mitigation techniques, and evaluation of parameters required for optimized transmission in multiple xDSL channels.

### BACKGROUND OF THE INVENTION

Digital subscriber line (DSL) technology is used to transform an ordinary telephone line (e.g., copper wire twisted-pair) into a broadband communication link. It works by sending signals over the telephone line in previously unused high frequencies.

Over the years, DSL technology has evolved into a family of specific, standardized implementations. These various implementations offer a variety of transmission speeds and transmission distances. One DSL or xDSL line (which can also be called a DSL channel or a DSL carrier in the frame of the present application) is presently able to transmit information in both directions via 1 to approximately 4000 frequency bins (sub-carriers). An DSL system comprises a group of DSL lines; usually, a plurality of DSL lines of the same system form a common binder or cable.

It is common to refer to the various DSL implementations that have evolved over the years collectively as xDSL. A number of factors determine the performance of the various xDSL implementations. For example, the performance of any of the xDSL implementations is highly dependent on the local loop length (e.g., the length of a twisted-pair circuit between a central office and a customer) and the local loop condition. The local loop condition is affected by several factors such as, for example, line noise. Line noise may corrupt data-bearing signals as the signals travel along the line. As a result, the transmitted data-bearing signals may be decoded erroneously by a receiver because of this signal corruption.

Therefore, a number of noise mitigation techniques/strategies have been developed for xDSL systems.

Internally generated noise sources are mostly influenced by the transceivers' design of central office (CO) and customer premises equipment (CPE) and generally cannot be mitigated through deployment practices. Robustness to loop impairments and internal noise sources can be improved through system design guidelines and advanced DSL transmission technologies, such as adaptive echo-canceller, adaptive hybrid and programmable digital/analog filters.

External stationary noise limits, such as crosstalk, are often accounted for in network design. Spectral compatibility is ensured by imposing restrictions on the transmit power PSD masks (Power Spectral Density mask). Operators usually control parameters related to transmit PSD in order to minimize crosstalk to neighboring lines. Advanced upstream and downstream power back-off techniques UPBO and DPBO are now commonly used and have been introduced in a number of ITU-T standard recommendations, such as G.997.1 (Physical layer management for digital subscriber line—DSL-transceivers), G.993.2 (Very high speed digital subscriber line transceivers 2-VDSL2), and also G.992.3 and G992.5 (for ADSL2 and ADSL2+).

Downstream power back-off (DPBO). The objective of the DPBO method is to reduce the downstream transmit PSD (Power Spectrum Density) injected at a street cabinet to the same level that would be expected to exist on the DSL line going down from the Central Office CO at the same point.

DPBO is performed at a street cabinet to improve spectral compatibility between VDSL2 systems and ADSL systems located at Central Office CO on loops of different lengths deployed in the same binder.

The frequency dependent loop attenuation H (f, L) of the cable section from the CO to the street cabinet is given by the following three-parameter model, where a, b, c, are some positive constants and L is the electrical length in dB (defined in G.997.1):

H(f,L)=(a+b×√f+c×f)×L dB [1]

Upstream power back-off (UPBO) is a mechanism where users apply back-off to their upstream transmit PSD. The reduction of PSD is performed at a transmitter end to improve spectral compatibility between VDSL2 systems on loops of different lengths deployed in the same binder.

The following power reduction UPBOMASK(kl₀,f), defined in G.993.2, is used, where the a, b and kl₀ are static user configurable parameters. (It should be kept in mind that parameters a, b in the UPBO technique have nothing in common with the similarly named parameters a, b in the DPBO technique. However, since the existing similar designations of the different parameters are accepted in the art, including the standards, they will be used as are in the present description.)

UPBOMASK(kl₀,f)=UPBOPSD(f)+LOSS (kl₀,f)+3.5 [dBm/Hz] [2]

where
LOSS (kl₀,f)=kl₀*\sqrt{f} [dB]
UPBOPSD(f)=−a−b*\sqrt{f} [dBm/Hz], and where
UPBOMASK is a PSD mask for the upstream transmit (i.e. from the user towards the CO), calculated as a function of the electrical length of the loop kl₀ and frequency f;
LOSS is a model of the loss function, depending on f and electrical length kl₀;
UPBOPSD is a reference PSD, used for calculation of the UPBOMASK.

Virtual noise (VN) is another technique introduced in the G.993.2 (VDSL2) standard to increase line stability (G.993.2, clause 11.4.2.1). Virtual noise is added to the line over the tones (frequencies) that are expected to be impacted by crosstalk from a neighboring line switching on. Virtual noise (VN) concept is a way to selectively increase the noise margin at specific frequencies at the receiver of the line, where one expects future increase of noise power. As a result, the SNR margin is determined for the conditions when both virtual noise and crosstalk noise from the line are present. FIG. 1 (prior art) describes the well-known effect of adding virtual noise in the low frequency band of the VDSL spectrum.

As shown in FIG. 1, noise margin will adapt to accommodate virtual noise. Noise margin can remain low at the tones that are not impacted by crosstalk for maximum bandwidth availability. Virtual noise mitigation technique is not dynamic and often results in a conservative bit loading.

Crosstalk is one of the main limitations of DSL performance today. Static Spectrum Management (fixed spectral masks) ensures that DSL lines in the same cable (binder) are spectrally compatible under worst-case crosstalk assumptions.

Dynamic Spectrum Management (DSM) increases capacity utilization by adapting the transmit spectra of DSL lines to the actual time-variable crosstalk interference. DSM comprises a set of techniques for multi-user power allocation and/or detection in DSL networks to ensure spectral compatibility under crosstalk assumptions.

With DSM, crosstalk is either reduced by shaping the spectra of the transmit signals, or is (partially) cancelled within the binder. These techniques are very effective for deployment scenarios where crosstalk is the dominant source of impairment. There are four levels of DSM coordination:

1) DSM Level 0 corresponds to static spectrum management (SSM) maximizing individual DSL line performance without considering the performance of neighboring lines.
2) DSM Level 1 deals with an autonomous power allocation management used for crosstalk avoidance.
3) DSM Level 2 is a centralized power allocation management between neighboring lines to avoid crosstalk.
4) DSM Level 3 is used for crosstalk mitigation. It can be used only when either transmitters and/or receivers are collocated.

Yet another technique is known for testing transmission lines—SELT (Single End Line Testing)—that generally evolved from ITU-T Standard Recommendation G.996.1. Some relevant parameters of SELT were described in 08CS-U09R2 from ITU meeting in Geneve, Belgium—16-20 Jun. 2008. For example, SELT allows obtaining excessive noise of lines in xDSL band, by determining a line with excessive noise (upstream and downstream) and a characterization of the most likely source of the noise. Also, SELT allows estimating SNR for a specific frequency range.

US2008/0031313 A1, “Performance Stabilization for Multi-Carrier DSL”, inter alia, describes how Virtual Noise (VN) is calculated (paragraph 5, FIG. 4). Empirical models and arbitrary values/functions are used for determining the Virtual Noise parameter, and such models are often inaccurate for DSL lines having specific, not averaged characteristics.

EP 1919 093 A1 sets a task of adaptive dynamic power adjustment in DSL lines based on reduction of cross-talk between the lines. The reference suggests calculating power spectrum density of crosstalk to a line from adjacent lines, obtaining its derivative—a crosstalk function, and, based on that data, calculating a transmitting power spectrum density (PSD) of a local device and controlling the transmitting power of the local device.

Krista S. Jacobsen, “Proposal for Upstream Power Back-Off for VDSL,” ITU contribution FI-075, February 2000, describes a method of determining UPBO, by utilizing a reference length technique and an equalized FEXT (Far End CrossTalk) technique. An empiric model (called an equalized FEXT method) is used for determining the parameter UPBO; models based on equalized characteristics are usually inaccurate and inappropriate for management of specific lines in xDSL systems.

To the best of the Applicant's knowledge, none of the prior art sources describes a practical way of determining transmission parameters for such xDSL noise mitigation techniques, as DPBO, UPBO and VN. None of the known prior art references presents tools for systematic and accurate determining of such parameters for each individual line of the xDSL system.

### OBJECT AND SUMMARY OF THE INVENTION

It is therefore the object of the present invention to propose a modern and practical technology for noise mitigation, based on the conventional DPBO, UPBO and VN technologies but being free from the above-mentioned disadvantages. The purpose of the invention is to enable improved (possibly dynamic) and more accurate determination of parameters required for management of transmission in xDSL channels.

It has been noted by the Inventors that, by now, nobody has proposed combining the noise mitigation techniques of DPBO, UPBO and VN with systematic determining of crosstalk readings at each and every line of the xDSL binder. In particular, it has never been proposed to combine these noise mitigation techniques with the DSM (Dynamic Spectrum Management) mechanism.

To achieve the above object, the Inventors propose a method of noise mitigation in a multi-channel xDSL system (binder), comprising determination of one or more parameters characterizing transmission via a group of channels of the multi-carrier (multi-channel) xDSL system, the parameters being selected from those required for one or more noise mitigation techniques from a list comprising at least the VN, DPBO and UPBO techniques, the method comprising:

obtaining individual cross-talk characteristics for each channel of said group of channels,

based on the obtained individual cross-talk characteristics, determining such values of said one or more parameters characterizing transmission via each channel of said group of channels, which values allow improving the obtained crosstalk characteristics at said two or more channels when utilizing said one or more noise mitigation techniques with said determined parameters.

In other words, the main idea of the method is to use the obtained cross talk estimation information “to configure” the existing noise mitigation techniques (mechanisms) such as DPBO, UPBO and VN. The term “to configure” means determining values of parameters of these mechanisms.

Actually, the method further comprises a step of utilizing the mentioned one or more noise mitigation techniques (DPBO, UPBO, VN) with the determined per channel values of the parameters, thereby achieving improvement of cross-talk characteristics at the two or more channels of the xDSL line. The techniques DPBO, UPBO, VN are independent; they can be applied separately or together, in any combinations and on any selected channels (lines) of the xDSL system.

The step of obtaining individual cross-talk characteristics for each of the two or more channels of the multi-carrier xDSL line may comprise just direct measurement of the individual cross-talk characteristics at the two or more channels (for example, measuring so-called FEXT couplings—Far End Cross Talk couplings i.e. disturbances from neighbor lines). However, the method preferably comprises determining these characteristics by applying a Dynamic Spectrum Management (DSM) mechanism (of Levels 2 or 3). This will make the noise mitigation techniques not only individual for each channel, but also dynamic.

When applying the DSM (Level 2 or Level 3) mechanism to an xDSL system according to the proposed method, the method actually utilizes the cross talk channel estimation which is achievable by means available in the DSM level 2 (DSM level 3). For example, (for DSM Level 3), the cross talk channel estimation is performed via a slicer error analysis.

The slicer error analysis can be implemented in a number of ways, one of them is by measuring an error signal at the receiving end, while using the knowledge of the transmitted data, for estimating FEXT (Far End CrossTalk) of the channel.

For DSM Level 2, the Inventors propose a specific cross-talk estimation algorithm which, for example, comprises measuring a so-called Quiet line noise by the receiver of the line, and measuring a transmitter PSD of a disturbing line, to estimate the magnitude of the FEXT coupling (disturbance) from the disturbing line to the disturbed line. The Quiet line noise is considered to be the noise in a line carrying no transmission and exposed to crosstalk.

The magnitude of the FEXT coupling can be thus estimated as a difference, in dB, between the measured Quiet line noise and the transmitter PSD of the disturbing line.

We now return to configuring parameters of the noise mitigation techniques DPBO, UPBO, VN.

The DPBO technique can be configured by optimized determining its a, b, c, parameters, taking into account the crosstalk channel measurements/estimations.

To configure the UPBO technique, its optimized UPBO parameters a, b should be found, using the performed crosstalk estimation/measurement per channel.

Similarly, the Virtual Noise (VN) technique, according to the invention, can be configured, for example, through the actual FEXT coupling matrix which is found by a crosstalk estimation algorithm utilized for DSM Level 2 or 3, and using the actual PSD of the relevant modem. For the VN technique, the discussed parameters of the technique are values of the minimal level of VN per frequency bin (subcarrier) in a channel (line or carrier) of the xDSL system.

The xDSL systems/lines may be those provided with DSM capabilities (i.e., equipped with suitable hardware/software means adapted to perform DSM), however the xDSL lines may belong to old systems where no DSM is supported.

(It is to be noted that the DSM technique “per se” is an independent spectrum management technique, and it can be applied to one or more of the xDSL lines irrespective of applying to them the proposed method and/or the discussed noise mitigation techniques.)

With respect to applying to the xDSL system parameters “configured” according to the proposed method, it should be noted that the operator/a control program first decides which noise mitigation techniques are to be applied and to which lines. The operator/program may decide to perform “configuring” of parameters of one or more of the noise mitigation techniques for some specific lines (channels) in the xDSL system, while not performing that for the remaining lines of the system.

The Inventors further propose combining the proposed method with SELT technique, for achieving more accurate results (configured parameters.

For deciding/selecting; which lines of the xDSL system need to be handled first, SELT mechanism can preliminarily be applied to the xDSL system. In other words, the proposed method for configuring parameters of noise mitigation techniques may comprise a preliminary step for estimating excessive noise in lines of the xDSL system, namely by applying a SELT mechanism; the method of configuring parameters is then performed for two or more lines of the system where the excessive noise is maximal according to SELT estimations.

It should be noted that for the case of applying the VN noise mitigation technique, the SELT mechanism may simulate the step of obtaining individual cross-talk characteristics for xDSL lines per subcarrier, since it allows determining excessive noise in DSL bands and characterization of a most likely source of the noise.

The parameters of interest for the VN technique (namely the values of minimal VN per frequency bin and per channel), can be then obtained just by adjusting the respective values obtained using SELT by a constant (measured in dB) obtained from a MIB (management information base) of the customer and preconfigured for each customer according to its desired noise sensitivity.

SELT information can also be used for configuring parameters of noise mitigation techniques DPBO and UPBO, and it will be further explained in the detailed description.

It is known from the practice, that when a new line is activated in an existing xDSL system, it may cause problems to other lines in the system. Dropping a line from an existing xDSL also changes an existing balance between the lines. The Inventors have proposed to use the information, available when performing the above-described method, for adjusting parameters of operative xDSL lines so as to limit the effect of a newly activated line/a dropped line.

For improving the xDSL system stability, the method may optionally comprise a step of pre-estimating an effect of introducing a new line(s) to or dropping a line(s) from a specific existing xDSL system, as if the system has already converged to its new stable state.

Preferably, the pre-estimation step is applicable to xDSL lines which have already been introduced in the xDSL system at least once (for example, a line that was taken for a periodic maintenance or for repair, a line which was in use and now is spare, etc.). Such a practice of maintaining xDSL lines is common. In the lifecycle of a line, it is often introduced once and then is being taken for maintenance periodically. So in most cases the pre-estimation is performed for lines which have already been introduced at least once.

The pre-estimating step, if performed, should bring pre-calculated optimized parameters for all lines of all practically expected configurations of the available xDSL system, and such parameters (being the object and the result of the pre-estimating step) should be stored in a ready-for-use form in some Management Entity, for example in a Network Management System. In this way, when a specific additional line actually comes up to a specific existing system (or dropped from a specific existing system), the lines will be immediately configured to the pre-calculated and pre-stored optimized parameters of the resulting system, and the system will be stable in the new state, thus saving the convergence time and the artifact of lines going down and up, that otherwise would be associated with the convergence process.

Optimized parameters for any specific xDSL system can be obtained by preliminarily performing all operations of the inventive method on the practically formed specific xDSL configuration.

According to a further aspect of the invention, there is provided a system for noise mitigation in a multi-line xDSL system, which comprises that multi-line xDSL system formed between a Central Office CO and two or more subscribers via at least one street Cabinet, the system for noise mitigation also comprising a Network Management System (NMS) with an interface for intercommunication with the xDSL system via either the CO or said at least one street Cabinet. The NMS is capable of obtaining individual crosstalk information for two or more lines of the xDSL system via the interface, is provided with software means for determining, based on said cross-talk information, optimized parameters of one or more noise mitigation techniques selected from a list comprising VN, DPBO and UPBO for said two or more lines. The NMS is also operative to provide the determined optimized parameters via the interface to said CO or said at least one street Cabinet, for further applying said at least one of the noise mitigation techniques to at least one of said two or more lines for reducing cross-talk.

According to yet another aspect of the invention, there is also provided a program (software) product, stored on a computer readable carrier medium, suitable for being installed in a Central Office, a street cabinet, and/or a Network Management System, the program product comprising computer implementable instructions and/or data which, when being utilized, allow carrying out the above-described method.

There are further provided a Network Management System, a Central Office and a street Cabinet, being respectively equipped with the mentioned software product.

The invention will be further explained in more details as the description progresses.

### BRIEF DESCRIPTION OF THE DRAWINGS

The invention will be described and illustrated with the aid of the following non-limiting drawings in which:

FIG. 1 (prior art) illustrates the accepted concept of introducing virtual noise VN, to accommodate expected crosstalk, to multiple channels of an xDSL system, having different frequency.

FIG. 2 is a block diagram schematically illustrating the general idea of the proposed algorithm for determining transmission parameters for DPBO or UPBO noise mitigation technique.

FIG. 3 is a block diagram schematically illustrating an xDSL system of lines extending between a central office CO, a street cabinet and a plurality of users, in particular for explaining how the DPBO noise mitigation mechanism can be utilized.

FIG. 4 is a block diagram schematically illustrating an xDSL system of lines extending between a plurality of users and a central office CO/a street cabinet, for explaining how the UPBO noise mitigation technique can be utilized.

FIG. 5 is a block diagram schematically illustrating one version of the proposed algorithm for determining transmission parameters for VN noise mitigation technique.

FIG. 6 schematically illustrates a block diagram of one embodiment of the inventive system for noise mitigation in xDSL lines.

### DETAILED DESCRIPTION OF PREFERRED EMBODIMENTS

The following detailed description presents examples of implementing the proposed method.

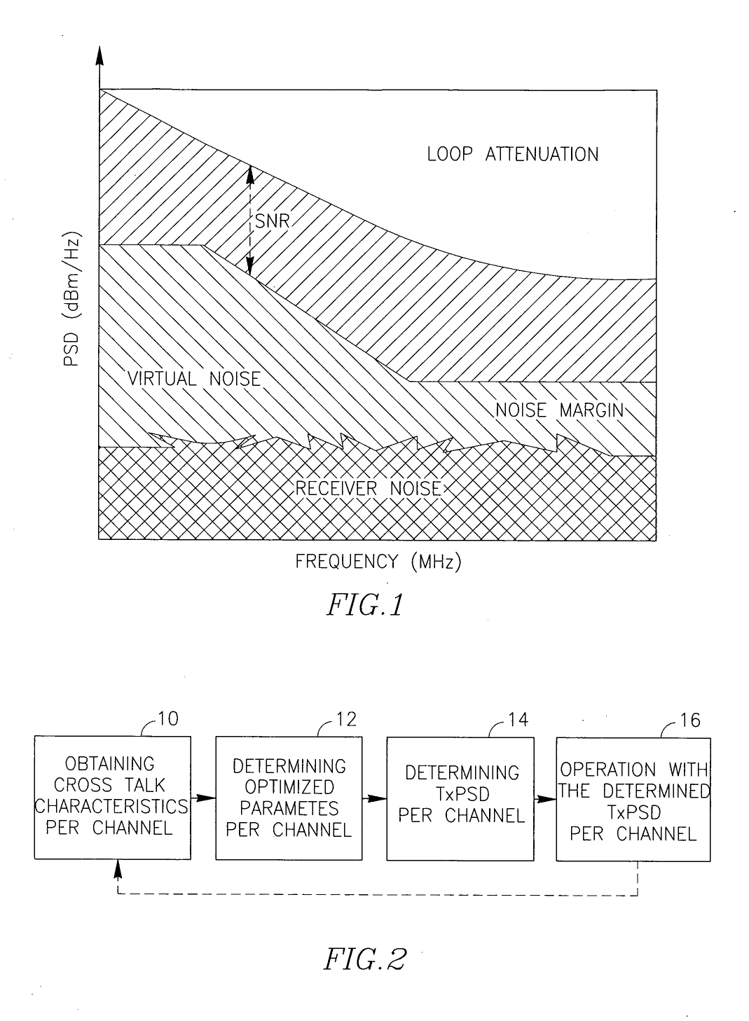

FIG. 2 illustrates a block diagram, where block 10 is responsible for obtaining FEXT estimation for each individual channel of xDSL system.

Block 10 can be just a FEXT measuring block or, alternatively, can be a block adapted to perform DSM estimation of channels' crosstalk characteristics.

In the latter case, the following operations are preferably performed in Block 10:

Transmitting pilot signals over the channels, for each channel obtaining a slicer error value from the far-end of the channel and estimating the FEXT by correlating between the slicer error and the pilot signal. Alternatively, the FEXT magnitude can be determined by using the least square minimization to estimate FEXT based on the near-end PSD and the measured Quiet line noise.

Block 12 is responsible for obtaining parameters a, b, c for DPBO (or parameters a, b for UPBO) on the basis of data obtained by block 10 and using the equations proposed by the Inventors and presented below.

Block 14 obtains information from block 12 and computes the transmitter's Power Spectrum Density (TxPSD) for each channel/line. For the DPBO technique, the TxPSD relates to the downstream transmitter of a specific channel, located at the street cabinet CAB, while for the UPBO technique the TxPSD relates to the upstream transmitter of a specific user. After determining the relevant parameters and the TxPSD, the channels are provided with that information and start operating, thus performing the suitable noise mitigation technique DPBO or UPBO (block 14). Periodically or continuously, the operating system is supposed to perform the estimation again (block 10), and thus the crosstalk is re-checked and the parameters are updated again (see the feedback dotted line from 16 to 10).

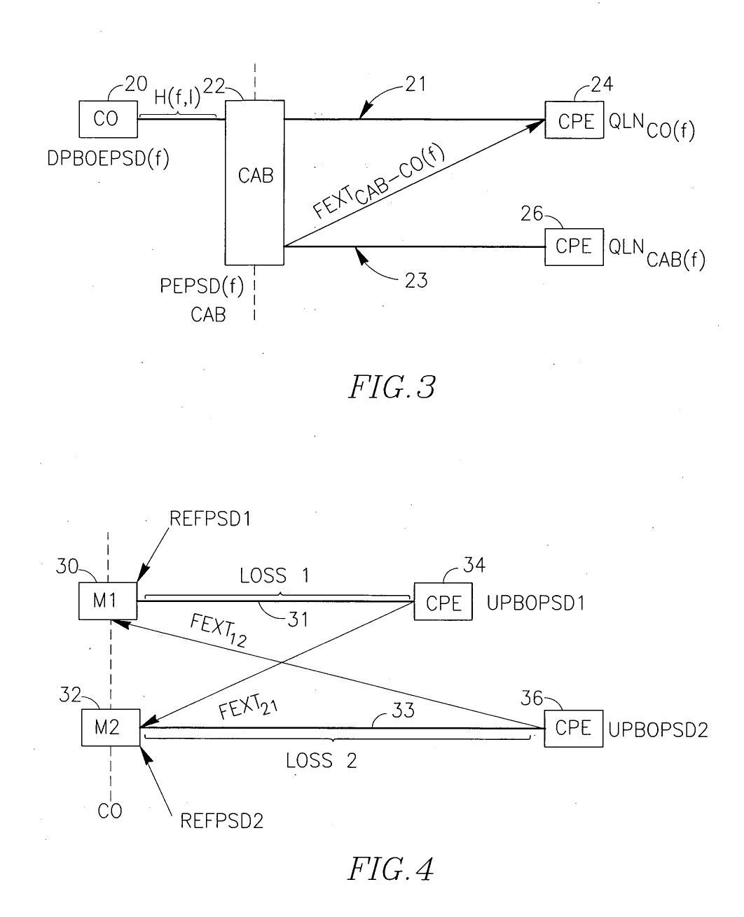

We will now refer to FIG. 3, schematically illustrating one xDSL line 21 starting from a Central Office (CO) 20, passing via street cabinet 22 and terminating at user 24, and another xDSL line 23, starting from the street cabinet 22 and terminating at user 26. Each of the users is provided with a Customer's Premises Equipment block (CPE).

Using the schematic diagram of FIG. 3, we will describe how the proposed DPBO mechanism is applied to a specific line.

As has been mentioned, the objective of the DPBO method is to reduce the downstream transmit PSD injected to line 23 at the cabinet 22, to the same level that would be expected to exist on a line (21) going down from the CO 20 at the same point (i.e., on the line of cabinet 22). The frequency dependent loop attenuation of the cable section from the CO 20 to the cabinet 22 is given by the three parameter model [1]:

H(f,L)=(a+b×\sqrt{f}+c×f)×L dB, where a, b, and c are positive constants (parameters) and L is the electrical length in dB.

We need to determine the a, b, c, based on the channel crosstalk estimation resulting from the DSM and on standard activation processes.

We determine the parameters, taking into account the following expressions. The notations CO, CAB refer to the origin of the lines.

PEPSD_{CAB}(f)=DPBOEPSD(f)−H(f,L) [3]

Where:

H(f,L)=(a+b×\sqrt{f}+c×f)×L (dB) [1];

PEPSD_{CAB}—is estimated PSD at the cabinet 22
DPBOEPSD—is estimated PSD at the CO 20;

Equation [3] gives PSD at the cabinet transmitter PEPSD_{CAB}(f) as a function of the assumed PSD of the CO transmitter DPBOEPSD(f), and of the assumed attenuation (power loss) on the segment between the CO and the cabinet.

PEPSD_{CAB}(f)−FEXT_{cab-CO}(f,)≦QLN_{CO}(f) [4]

### Where:

FEXT_{CAB-CO}(f) is the estimated FEXT of channels (lines 21 and 23) between the cabinet 22 and the CPE 24.
QLN_{CO}(f) is the Quiet Line Noise of channel 21 at CPE 24. Let both the FEXT_{CAB-CO}(f,) and the QLN_{CO}(f) are measured.

SNR_{CAB}(f)=PEPSD_{CAB}(f)−QLN_{CAB}(f) [5]

### Where:

QLN_{CAB}(f) is Quiet Line Noise of channel 23 at the CPE 26;
SNR—signal to noise ratio.

We may then select the (optimal) parameters a, b, c in [1] such, that the following three conditions are satisfied:

$${\sum }_{f = fDBPO} SNRcab ( f )$$

Where f_{DPBO}—is the maximal frequency of transmission for which the DPBO mechanism can be performed.

2) expression [4] is satisfied;
3) parameters a, b, c are within the allowed range, i.e.:

a_{MIN}≦a≦a_{MAX}; b_{MIN}≦b≦b_{MAX}; c_{MIN}≦c≦c_{MAX}

(According to standard recommendation ITU-T G.997.1, any of the parameters a, b, c should be within the range between −1.0 and +1.5).

In other words, the parameters a, b, c are optimized such that the total SNR below the DPBO maximal frequency (f≦f_{DPBO}) is maximized, and the crosstalk between the cabinet line 23 and the CO line 21 is less than some required noise level being QLN_{CO}(f).

For the specific case of the “cabinet-originating” line 23, the generalized TxPSD calculated in block 14 of FIG. 2 for the DPBO technique is the estimated PSD at the cabinet 22 (PEPSD_{CAB}). It can be obtained by plugging the determined parameters a, b, c into equation [3].

It should be further noted, that the value of f_{DPBO} (the maximal frequency of transmission for which the DPBO mechanism is applicable), can be configured by using SELT means for determining SNR together with SELT means for determining excessive noise in xDSL band. For example, if SELT means detect in the street cabinet that ADSL line is the disturber, the f_{DPBO} will be the minimal (1.1 Mhz, max frequency of SNR<N dB, (N could be 15 dB as an example).

Returning again to FIG. 2, it should be recalled that, according to the general concept proposed by the Inventors, FIG. 2 illustrates a schematic algorithm for determining parameters of the DPBO or UPBO noise mitigation techniques. The UPBO technique calculates the TxPSD which in the UPBO case is the user's transmitter transmitting upstream towards the cabinet and CO. The UPBO TxPSD is calculated based on the determined UPBO parameters a, b, which are obtained using the equations proposed below.

It should be kept in mind that parameters a, b, of UPBO do not have any relation to similarly called parameters a, b, c of DBPO.

FIG. 4 schematically illustrates how the UPBO technique can be applied to xDSL lines 31 and 33 of the same binder, having different lengths.

The lines 31 and 33 extend between respective users 34 and 36 at one side, and modems M1 and M2 which, for example, are both located at CO. Actually, the modems M1, M2 could be both located at the cabinet since it is principally irrelevant.

The UPBO is a mechanism where users (34, 36) apply back-off to their upstream transmit PSD. The back-off is determined by the “Reference PSD” which corresponds to the maximum transmit PSD that can be used on a loop of length zero (i.e., an imaginary loop having a zero electric length).

The reference PSD has notation UPBOPSD(f) in [2], but below it is called just REFPSD(f). It is parameterized in each upstream band (a number of consecutive frequency bins) by the positive UPBO parameters a, b according to the formula:

REFPSD(f)=−a−b·\sqrt{f} dBm/Hz [6]

In the following example we show how the cross talk channel estimation obtained by DSM techniques can be used to optimally select the a, b UPBO parameters for two users channels such, that the FEXT that each user “sees” from the other is minimized.

Let M denote the minimum FEXT attenuation required by a user with respect to the received upstream signal in dB, for example M=50 means we want the FEXT that each user “sees” from the other to be at least 50 dB below the signal. This parameter M is a free parameter that can be configured by the operator.

In FIG. 4, User 1 is CPE 34, and User 2 is CPE 36, and we are going to discuss back-off action of their transmitters and physical parameters of their loops. We have the following definitions. (The definitions for user transmit PSD utilize the expression UPBOPSDi(f,L), which actually replaces UPBOMASK(kl₀,f) of [2], with a difference of 3.5 dB).

User 1 transmit PSD: UPBOPSD1(f,L)=REFPSD1(f)+LOSS1(kl_{o,f)}

User 2 transmit PSD: UPBOPSD2(f,L)=REFPSD2(f)+LOSS2(kl₀,f)

User 1 FEXT attn: UFXTATT1(f,L)=REFPSD1(f)−UPBOPSD2(f,L)·FEXT12(f)

User 2 FEXT attn: UFXTATT2(f,L)=REFPSD2(f)−UPBOPSD1(f,L)·FEXT21(f)

The functions FEXT12(f) and FEXT2(f) are the FEXT (far end cross talk) channel estimations obtained by a DSM technique. The problem is to optimally choose the REFPSD parameters of the two users (namely a1, b1, a2 and b2, see [6]) such, that the following conditions are satisfied:

UFXTATT1(f,L)≧M

UFXTATT2(f,L)≧M

Additional constraints on the a, and b parameters can be imposed, such as the minimum transmit power, adherence to regional PSD masks and so on. This problem can be solved by several methods such as algebraic solutions, or through standard optimization methods like linear programming. The proposed method can be extended to more than two users in quite a straightforward fashion.

As can be seen, the TxPSD calculated by box 14 in FIG. 2 for UPBO is the User transmit PSD, per channel of the xDSL system.

As shown above, UPBO is dependent on loop length L. The length is usually measured during the activation but could be override by a parameter UPBOKL (kl₀) stored in the client's MIB (Management Information Base). SELT measurements could be used to configure the UPBOKL parameter with high accuracy.

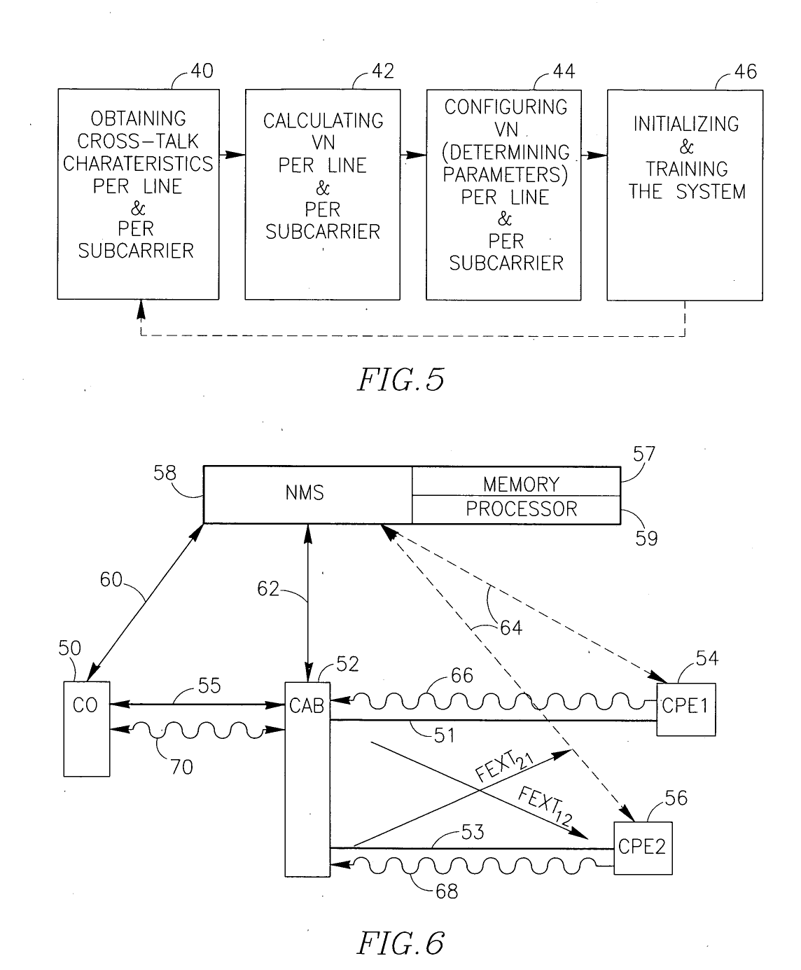

FIG. 5 presents an exemplary sequence of steps for determining parameters of VN (virtual noise) technique, according to the general concept proposed by the Inventors.

Virtual Noise VN technique, according to the invention, can be configured, for example, through the actual FEXT coupling matrix which is found by a crosstalk estimation algorithm (say, one of those mentioned for DSM Level 2 or DSM Level 3), and the actual PSD of each relevant modem. The proposed method therefore uses values of actual FEXT coupling and of PSD per each frequency bin of a specific line/modem. The virtual noise VN is always determined for the receiver of a specific transmission, the direction of the transmission is irrelevant.

The discussed parameters of the VN technique are values of the minimal level of VN per frequency bin in a channel (line) of the xDSL system.

Block 40 performs determining of FEXT values (by either technique, and preferably by DSM) per sub-carrier (frequency bin) of each carrier (channel or line). Block 42 calculates the Virtual Noise value function VN for each channel based on the obtained FEXT values. Block 44 performs configuring of the VN function for each channel/line and for each frequency bin/subcarrier, i.e. determining the parameters of interest (VNₘᵢₙ per frequency bin on a line) based on some mathematical expressions and the VN functions obtained by block 42.

Upon configuring the VN function for each channel, the system of communication channels, including transceivers and links, is initialized/trained (Block 46) so that the transceivers take into consideration the configured VN parameters during the modems' training. The feedback—dashed line between block 46 and block 40—may be based on updates to the FEXT and background noise (BGNoise) estimates.

The configuration of VN on a per line and per subcarrier basis (Block 44) can be accomplished with the help of the FEXT and background noise estimates which can be both provided by the DSM mechanism (Block 40). In a specific example comprising two users, let BGN1(f) and BGN2(f) be the background noise estimates at receiver 1 and receiver 2 of user 1 and user 2 respectively. Also, FEXT21(f) and FEXT12(f) are the FEXT “channels” from user 1 to user 2 and vice versa. Then the total noise at each receiver can be estimated by:

TOTNOISE1(f)=BGN1(f)+TxPSD2(f)·FEXT12(f)

TOTNOISE2(f)=BGN2(f)+TxPSD1(f)·FEXT21(f)

Where TxPSD1(f) and TxPSD2(f) are the transmit PSD of user 1 and user 2 respectively. Since VN can be applied both for upstream and for downstream directions, the users can be understood as the transmitters of the CO/cabinet or of the CPE.

The VN can be configured for each user as follows:

VN1(f)≧TOTNOISE1(f)

VN2(f)≧TOTNOISE2(f)

The total noise estimates give a lower limit on the VN configuration, which is the main parameter of interest of the VN technique. The main parameter of interest of the VN technique is therefore the lower limit of VN per line, per frequency bin. The exact level of VN can be determined by a tradeoff between robustness and capacity. This method can be extended to more than two users in a straightforward fashion.

It should be noted, however, that if SELT mechanism is utilized for VN technique, the cross-talk channel estimation can be simulated (actually, substituted) by determining excessive noise in xDSL band per frequency bin. The parameters of interest for the VN technique (namely the values of minimal VN per frequency bin and per channel), can be then obtained just by shifting the respective values obtained using SELT by a constant (say, by additional 3 dB) obtained from a MIB (management information base) of the customer and preconfigured for each customer according to its desired noise sensitivity.

Returning again to FIG. 2, it should be noted that the cross-talk channel estimation information, obtained at block 10 of FIG. 2, can be further used for pre-estimation of possible optional states of the xDSL system. For example, that information may be useful for pre-estimating an effect of activating a new line in the xDSL system, or an effect of dropping any of the existing lines. The pre-estimation comprises virtually re-determining parameters for each line in a new system, and storing the re-determined parameters for possible further use. The “new system” may have various configurations (number of lines, specific lines participating); all practical configurations should be pre-calculated and parameters of the lines are to be stored.

FIG. 6 schematically illustrates a block diagram of an exemplary system for noise mitigation in xDSL lines according to the invention.

The system comprises a multi-line xDSL system formed between a Central Office CO 50, usually via a street Cabinet CAB 52 (only one is shown in the figure) and between multiple subscribers. The subscribers are provided with respective CPEs; only two subscribers with CPEs 54, 56 are shown for simplicity, being connected via xDSL lines 51, 53 to the cabinet 52 and via line 55 to the Central Office 50. The CO 50 and the Cabinet 52 preferably comprise respective DSLAMs (Digital Signal Line Access Multiplexers; not shown). The exemplary system for noise mitigation is shown as comprising a Network Management System (NMS) 58 being in intercommunication with the xDSL system (lines 60, 62 and optional 64) in order to

a) obtain there-from, via an adapted interface, cross-talk estimations or direct crosstalk measurements of two or more xDSL lines,
b) based on the obtained cross-talk information, determine optimal parameters of one or more noise mitigation techniques (DPBO, UPBO, VN), per line, by means of the software product according to the invention, and
c) provide the xDSL system, via the interface, with the determined optimal parameters of one or more noise mitigation techniques (DPBO, UPBO, VN) calculated per line, and preferably with instructions for further applying one or another of these techniques to one or another of the specified xDSL lines.

The cross-talk information per individual xDSL line can be obtained at CO 50 and/or CAB 52 by utilizing functionality of their DSLAMs, for example by applying the DSM mechanism in case the DSLAM is equipped with such. However, cross-talk can be directly measured at any one of blocks CO, CAB or CPE by using some specifically provided equipment (not shown). Cross-talk information (say, FEXT₁₂ and FEXT₂₁) obtained at the customers' sites is usually transmitted to the Cabinet (wavy lines 66, 68) and/or to the CO (wavy line 70), from where it is sent to the Network Management System (NMS) 58. NMS may be a software entity, a hardware entity or may incorporate both. The NMS 58 preferably incorporates SELT tools. In FIG. 6, the NMS 58 is a server comprising at least a memory 57, a processor 59 and additionally incorporating a software product responsible for performing the method of the invention. The software product in the NMS is capable of processing the cross-talk information obtained by the NMS from CO (CAB, CPEs), preferably selects lines of the xDSL system for further noise mitigation, and performs calculation of optimized parameters for applying specific noise mitigation techniques to specific lines of the xDSL system. Under control of the software product, NMS 58 then forwards the optimized parameters, determined for specific xDSL lines, to blocks CO, CAB (optionally to CPEs), and by that actually informs the blocks which techniques should be initiated and at which lines.

The NMS preferably keeps storing, in its memory 57, information about optimal parameters per xDSL line for various configurations of the xDSL system. Such information can be accumulated, for example, during the combined long term exploitation of the xDSL system (where specific lines can be added or dropped from time to time) under supervision of the noise mitigation system. The information about optimal parameters per line, preliminarily stored for various xDSL configurations, can be further used for pre-estimation of changes in the new required xDSL system where a specific line is to be added or dropped. Actually, if the new required configuration of xDSL system had already been processed and its optimal parameters were stored, they can immediately be applied and undesired transition processes will be eliminated.

In other words, for pre-estimating an effect of introducing a new channel to the xDSL system or dropping an existing channel from the xDSL system to form a new xDSL system, the system will pre-calculate the optimal one or more parameters for all channels of various configurations of the multi-channel xDSL system, and store these parameters in the memory 57 for possible further use. It remains only to find among the various configurations, stored in the memory, a configuration identical to the expected new xDSL system and to apply the pre-calculated parameters of that stored configuration to the channels of the new xDSL system.

It should be appreciated that additional versions of the method, the system and the system elements can be proposed for implementing the inventive idea, and that these versions should be considered part of the invention as far as being defined by the claims which follow.

1-19. (canceled)

20. A method for noise mitigation in a multi-channel xDSL system, comprising determination of one or more parameters characterizing transmission via two or more channels of the multi-channel xDSL system, the parameters being selected from those required for one or more noise mitigation techniques selected from a list comprising at least VN, DPBO and UPBO, the method comprising:
obtaining individual cross-talk characteristics for each of the two or more channels of the multi-channel xDSL system, and
based on the obtained individual cross-talk characteristics, determining such values of said one or more parameters characterizing transmission via each of said two or more channels of said xDSL system, which values allow improving the obtained crosstalk characteristics at said two or more channels if utilizing said one or more noise mitigation techniques with the determined parameters.

21. The method according to claim 20, wherein the step of obtaining individual cross-talk characteristics for each of the two or more channels of the multi-channel xDSL system comprises either determining them by utilizing Dynamic Spectrum Management (DSM) mechanism, or directly measuring said individual cross-talk characteristics at said two or more channels.

22. The method according to claim 21 wherein the step of obtaining individual cross-talk characteristics is performed by utilizing either a DSM Level 3 mechanism, by applying a slicer error analysis, or by utilizing DSM Level 2 mechanism, by applying an algorithm comprising:
measuring a Quiet line noise by a receiver of a disturbed line, measuring a transmitter PSD of a disturbing line, and
estimating the magnitude of the FEXT coupling from the disturbing line to the disturbed line as a difference between the measured Quiet line noise and the transmitter PSD of the disturbing line.

23. The method according to claim 20, wherein the noise mitigation technique being VN, and wherein said parameters comprise a set of values of minimal level of VN at respective frequency bins per channel of the xDSL system.

24. The method according to claim 20, further comprising a step of pre-estimating an effect of introducing a new channel to the xDSL system or dropping an existing channel from the xDSL system, thereby forming an expected new xDSL system, the pre-estimating step comprises pre-calculating said one or more parameters for all channels of various configurations of the multi-channel xDSL system, and storing said pre-calculated parameters in a memory for possible further use.

25. The method according to claim 24, further comprising
finding among the various configurations stored in the memory a configuration identical to the new xDSL system; and
applying the pre-calculated parameters of the found configuration to the channels of the new xDSL system formed upon adding the new channel or dropping the existing channel.

26. The method according to claim 20, comprising utilizing a SELT mechanism.

27. The method according to claim 26, comprising a preliminary step of estimating excessive noise in lines of the xDSL system by applying a SELT mechanism, and determining said one or more parameters for the lines where the excessive noise is maximal according to SELT results.

28. The method according to claim 26, wherein in case of applying the VN noise mitigation technique, the step of obtaining individual cross-talk characteristics for each of the two or more channels of the multi-channel xDSL system is simulated by utilizing the SELT mechanism per subcarrier.

29. The method according to claim 26, comprising utilizing the SELT mechanism for configuring one or more parameters of the noise mitigation techniques DPBO and/or UPBO.

30. A system for noise mitigation in a multi-line xDSL system, comprising the multi-line xDSL system formed between a Central Office CO and two or more subscribers via at least one street Cabinet, the system for noise mitigation also comprising a Network Management System (NMS) with an interface, being in intercommunication with the xDSL system via either the CO or said at least one street Cabinet; the NMS being therefore capable of obtaining individual crosstalk information for two or more lines of the xDSL system; the NMS further comprising software means for determining, based on said cross-talk information, optimized parameters of one or more noise mitigation techniques selected from a list comprising VN, DPBO and UPBO for said two or more lines; the NMS being operative to provide the determined optimized parameters via said interface to said CO or said at least one street Cabinet, for further applying said one or more of the noise mitigation techniques to at least one of said two or more lines for reducing cross-talk.

31. A software product comprising computer implementable instructions and/or data for carrying out the method according to claim 1, stored on an appropriate non-transitory computer readable storage medium so that the software is capable of enabling operations of said method when used in a computer system.
